(19) United States
(12) Patent Application Publication
(10) Pub. No.: US 2022/0381983 A1
(43) Pub. Date: Dec. 1, 2022

(54) FLEXIBLE OPTICAL WAVEGUIDE BOARD AND METHOD FOR MANUFACTURING THE SAME

(71) Applicant: SHENNAN CIRCUITS CO., LTD., Shenzhen (CN)

(72) Inventors: XIAOFENG LIU, Shenzhen (CN); Guodong Wang, Shenzhen (CN); Hua Miao, Shenzhen (CN); Tengfei Yao, Shenzhen (CN); Yongkai Li, Shenzhen (CN)

(21) Appl. No.: 17/509,088

(22) Filed: Oct. 25, 2021

Related U.S. Application Data
(63) Continuation of application No. PCT/CN2021/103274, filed on Jun. 29, 2021.

(30) Foreign Application Priority Data
May 28, 2021 (CN) 202110594305.X

(51) Int. Cl. G02B 6/122; G02B 6/13

(52) U.S. Cl. CPC G02B 6/1221; G02B 6/13; G02B 2006/12069

(57) ABSTRACT

A flexible optical waveguide board and a method of manufacturing the same are provided. The flexible optical waveguide board includes: a flexible substrate, wherein a surface of a side of the flexible substrate is a rough surface; an optical waveguide, disposed on the rough surface of the flexible substrate; a cover layer, disposed on a surface of a side of the optical waveguide away from the flexible substrate. In this way, structural reliability and environmental ageing resistance of the flexible optical waveguide board is improved.

### CROSS REFERENCE TO RELATED APPLICATIONS

The present application is a continuation-application of International (PCT) Patent Application No. PCT/CN2021/103274, filed on Jun. 29, 2021, which claims foreign priority of Chinese Patent Application No. 202110594305.X, filed on May 28, 2021, in China National Intellectual Property Administration, the entire contents of which are hereby incorporated by reference in their entireties.

### TECHNICAL FIELD

The present disclosure relates to the field of flexible optical waveguide, and in particular to a flexible optical waveguide board and a method of manufacturing the same.

### BACKGROUND

Compared to traditional electrical interconnection, optical interconnection may not be interfered by electromagnetic shielding, may have low energy consumption, and may provide high bandwidth and a high speed. In the future, the optical interconnection is a development trend of high-speed communication. In order to further save space, reduce sizes, and improve availability of wiring, a high-speed signal interface may be configured with optical wiring for transmission. At the same time, an electro-optical printed circuit board (EOPCB) may be formed. Such the transmission may be a development trend of a high-speed and high-capacity transmission board.

As a new optical transmission medium, polymeric optical waveguide attracts many attention from academic and industrial fields, especially considering that processing the polymeric optical waveguide may be highly compatible with processing a PCB, the polymeric optical waveguide may be wired flexibly, and densification of the polymer optical waveguide may be achieved easily. The polymeric optical waveguide may be fabricated on a rigid support substrate for attaching substrates. Further, the polymeric optical waveguide may also be fabricated on a flexible substrate to form a flexible optical waveguide board (FOPCB). The FOPCB can be freely bent, wound, and folded, and may be arranged according to spatial layout requirements. The FOPCB may be freely moved and expanded in a three-dimensional space. In this way, integration of component assembling and wire connection may be achieved to dramatically reduce a size and a weight of an electronic device, and may be suitable for the electronic device to be developed to have high density, to be miniaturization and to be highly reliable. Further, combination of the FOPCB having optical wiring and the conventional PCB having electrical wiring may form a flexible electro-optical printed circuit board (FEOPCB). The FEOPCB may be good at dissipating heat and may be highly weldable. Combination of rigidity and flexibility may remedy drawbacks of the flexible substrate which has slightly insufficient capacity for carrying components. The FEOPCB combines advantages of the flexible circuit board and the optical interconnection and may especially be suitable for a high-speed connection application scenario which has a narrow distance and a bent part, and has movable parts to be folded, and the like. Further, an end of the flexible waveguide may integrate pluggable standard fiber optic connectors, such that vertical coupling connection between a main board and a daughter board may be achieved. The Flexible waveguide may be combined with the traditional coupling connection mode, such that the coupling may be achieved at any angle and in any direction.

In the art, a limited number of literatures and patents teach synthesis of flexible waveguide material and fabrication of flexible waveguide circuits based on the flexible waveguide material. Overall, choices of the flexible waveguide material are very limited. Usually, organosilicon may be the waveguide material. However, the material generally has poor heat resistance. Conventional polymer waveguide, which is formed based on ultraviolet curing and cross-linking, is highly cross linked, forming a three-dimensional network structure. Under external forces, the conventional polymer waveguide may be brittle and fractured, unsuitable for manufacturing the FOPCB. Therefore, it is of great practical importance to perform structural innovation, to develop new waveguide processes, and to take non-flexible waveguide material to manufacture the FOPCB that has certain bending resistance and has a highly reliable structure, such that common waveguide resin material may be applied in the flexible waveguide board. Poor adhesion between the waveguide and the substrate is an urgent problem in the field of manufacturing the flexible waveguide.

### SUMMARY OF THE DISCLOSURE

The present disclosure provides a flexible optical waveguide board and a method of manufacturing the flexible optical waveguide board, such that structural reliability of the FOPCB in the art may be improved, and an ability of the FOPCB in the art being resistant to aging caused by environments may be improved.

According to an aspect of the present disclosure, a flexible optical waveguide board includes: a flexible substrate, wherein a surface of a side of the flexible substrate is a rough surface; an optical waveguide layer, disposed on the rough surface of the flexible substrate; a cover layer, disposed on a surface of a side of the optical waveguide layer away from the flexible substrate.

According to another aspect of the present disclosure, a method of manufacturing the flexible optical waveguide board includes: providing a flexible substrate, wherein a surface of a side of the flexible substrate is a rough surface; forming an optical waveguide layer on the rough surface of the flexible substrate; laminating a cover layer on a surface of a side of the optical waveguide layer away from the flexible substrate by a press-laminating device, wherein the cover layer and the flexible substrate serve as a flexible protective layer for the optical waveguide layer.

According to the present disclosure, a surface of a side of a flexible substrate may be configured to be a rough surface. An optical waveguide layer may be configured on the rough surface of the flexible substrate. In this way, adhesion between the optical waveguide layer and the flexible substrate is improved, and reliability of the adhesion between the flexible substrate and the optical waveguide layer is increased. A cover layer may be configured on a surface of an optical waveguide layer away from the flexible substrate. The cover layer protects the optical waveguide layer from external erosion, such that the ability of the FOPCB being resistant to aging caused by environments and the structural reliability of the FOPCB may further be improved.

### BRIEF DESCRIPTION OF THE DRAWINGS

In order to make the technical solution described in the embodiments of the present disclosure more clear, the drawings used for the description of the embodiments will be briefly described. Obviously, the drawings described below shows only a part of, but not all of, embodiments of the present disclosure. An ordinary skilled person in the art may obtain other drawings based on these drawings without making any creative work.

FIG. 1 is a structural schematic view of a flexible optical waveguide board according to a first embodiment of the present disclosure.

FIG. 2 is a structural schematic view of a flexible optical waveguide board according to a second embodiment of the present disclosure.

FIG. 3 is a structural schematic view of a flexible optical waveguide board according to a third embodiment of the present disclosure.

FIG. 4 is a flow chart of a method of manufacturing a flexible optical waveguide board according to an embodiment of the present disclosure.

### DETAILED DESCRIPTION

Technical solutions of the embodiments of the present disclosure will be clearly and completely described below by referring to the accompanying drawings of the embodiments of the present disclosure. Obviously, the embodiments described are only a part of, but not all of, the embodiments of the present disclosure. Based on the embodiments of the present disclosure, all other embodiments obtained by an ordinary skilled person in the art without any creative work shall fall within the scope of the present disclosure.

Terminologies used in the embodiments of the present disclosure is intended only for the purpose of describing a particular embodiment and does not limit the scope of the present disclosure. The singular word “a”, “said” and “the” used in the embodiments of the present disclosure and the appended claims may include a plurality of features, unless being clearly indicated otherwise. A “plurality” generally includes at least two of features, but does not exclude the situation of at least one of such the feature.

It shall be understood that, term “and/or” as used herein is simply a description of a relationship of associated objects, indicating three relationships. For example, A and/or B may indicate: A alone, both A and B, and B alone. In addition, the character “/” used herein generally indicates an “or” relationship between the objects in front of and after the character.

It shall be understood that, terms “includes”, “comprises” or any other variant used herein are intended to cover non-exclusive inclusion, such that a process, a method, an article or an apparatus including a series of elements includes not only those elements, but also other elements not expressly listed, or other elements are inherent to the process, the method, the article or the apparatus. Without further limitation, the inclusion of elements as defined by the statement “including . . . ” does not preclude presence of additional identical elements in the process, the method, the article or the apparatus.

The “embodiments” mentioned herein mean that particular features, structures or characteristics described in an embodiment may be included in at least one of other embodiments of the present disclosure. The occurrence of the phrase in every place in the specification does not necessarily mean the same embodiment, nor is it a separate or an alternative embodiment that is mutually exclusive with other embodiments. The ordinary skilled person in the art shall explicitly and implicitly understand that the embodiments described herein may be combined with other embodiments.

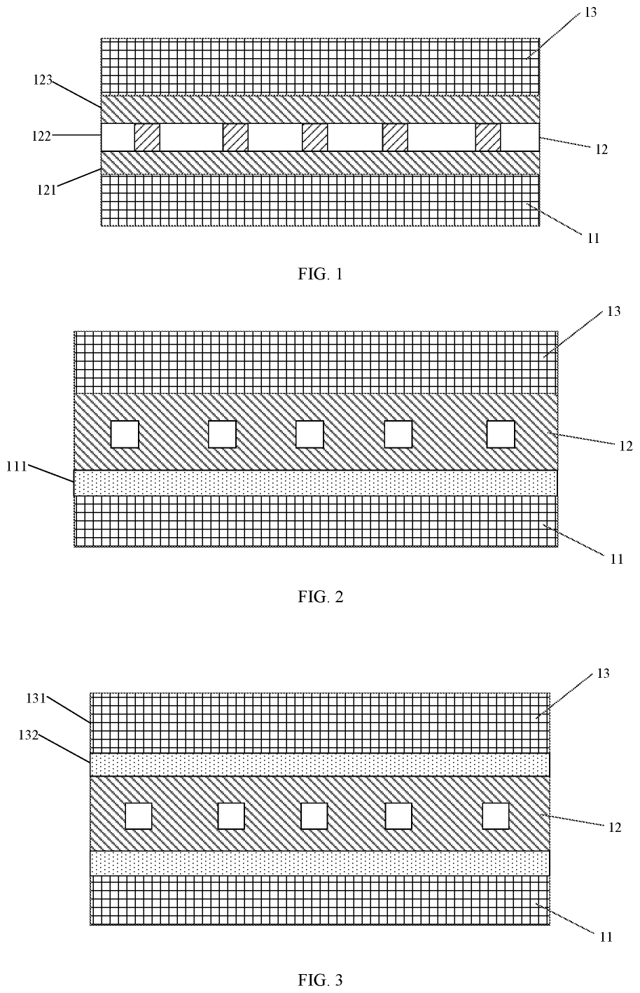

The present disclosure provides a flexible optical waveguide board, as shown in FIG. 1. FIG. 1 is a structural schematic view of a flexible optical waveguide board according to a first embodiment of the present disclosure. As shown in FIG. 1, the flexible optical waveguide board may include following components.

A flexible substrate 11 may be included. A surface of a side of the flexible substrate 11 may be a rough surface. In detail, a surface of a side of flexible substrate 11 close to the optical waveguide 12 may be the rough surface. An optical waveguide layer 12 may be included. The optical waveguide 12 may be disposed on the rough surface of the flexible substrate 11. A cover layer 13 may be included. The cover layer 13 may be disposed on a surface of a side of the optical waveguide layer 12 away from the flexible substrate 11. In another embodiment, surfaces of two opposite sides of the flexible substrate 11 may both be rough surfaces. The optical waveguide layer may be disposed on one of the two rough surfaces, and other structures may be disposed on the other one of the two rough surfaces. In this way, the utilization of the surfaces of the flexible substrate 11 may be improved. The present disclosure does not limit the arrangement of the rough surface of the flexible substrate 11.

The flexible substrate 11 is a flexible substrate plate, the cover layer 13 is a cover film layer, and the optical waveguide layer 12 is a polymeric optical waveguide plate.

The optical waveguide layer 12 further includes a waveguide lower clad 121, a waveguide upper clad 123 and a waveguide core layer 122 disposed between the waveguide lower clad 121 and the waveguide upper clad 123. In detail, the waveguide lower clad 121 is disposed close/adjacent to a side of the flexible substrate 11, and the waveguide upper clad 123 is disposed close/adjacent to a side of the cover layer 13. In the present embodiment, the waveguide core layer 122 is wrapped by the waveguide lower clad 121 and the waveguide upper clad 123 to form the optical waveguide layer 12. The waveguide lower clad 121 and the waveguide upper clad 123 serve as a protective layer for the waveguide core layer 122 to protect stability of the waveguide core layer 122. In an implementation, the waveguide lower clad 121 and the waveguide upper clad 123 wrap the waveguide core layer 122. The waveguide core layer 122 may include a plurality of optical waveguide units that are spaced apart from each other. The waveguide lower clad 121 and the waveguide upper clad 123 may be received in a gap between the plurality of optical waveguide units to completely wrap the waveguide core layer. Both the waveguide lower clad 121 and the waveguide upper clad 123 are optical resin layers, which are polymeric resin layers formed by a UV-curing and cross-linking process. The polymeric optical waveguide plate formed by the UV curing process is significantly brittle and may not be easily bent. In the present embodiment, bending resistance of the optical waveguide layer 12 may be significantly increased by providing the flexible substrate 11 and the cover layer 13 on two opposite sides of the optical waveguide layer 12.

In the present embodiment, the flexible substrate 11 includes any one or more of polyimide (PI), fluorosilicone rubber, polyetheretherketone (PEEK), perfluorovinyl propylene copolymer (FEP). The flexible substrate 11, which includes any one or more of polyimide (PI), fluorosilicone rubber, polyether ether ketone (PEEK), and perfluorovinyl propylene copolymer (FEP), has a low surface activation energy and is relatively smooth. Therefore, the surface of the flexible substrate 11 needs to be treated to improve adhesion between the flexible substrate 11 and the optical waveguide layer 12.

In an implementation, the rough surface of the flexible substrate 11 is treated by performing a plasma beam roughening process. In detail, the surface of the side of the flexible substrate 11 close to the optical waveguide layer 12 is roughened by a plasma beam, such that the rough surface is formed to improve the adhesion between the flexible substrate 11 and the optical waveguide layer 12.

In another implementation, the surface of the side of the flexible substrate 11 close to the optical waveguide layer 12 is roughened by performing a chemical etching process to form the rough surface, such that the adhesion between the flexible substrate 11 and the optical waveguide 12 may be improved. The present disclosure does not limit a process for forming the rough surface.

In still another implementation, the flexible optical waveguide board further includes an adhesion layer 111, disposed on the surface of the side of the flexible substrate 11 close to the optical waveguide layer 12 to form the rough surface. As shown in FIG. 2, FIG. 2 is a structural schematic view of a flexible optical waveguide board according to a second embodiment of the present disclosure. In detail, the adhesion layer 111 is disposed on the surface of the side of the flexible substrate 11 close to the optical waveguide 12 to form the rough surface, such that the adhesion between the flexible substrate 11 and the optical waveguide 12 may be improved.

In another embodiment, surfaces of two opposite sides of the flexible substrate 11 may be configured to be rough surfaces. The optical waveguide layer 12 may be disposed on one of the two rough surfaces, and other material may be disposed on the other one of the two rough surfaces. Alternatively, the optical waveguide layer 12 may be disposed on both rough surfaces of the two opposite sides, which will not be limited by the present disclosure.

In the present embodiment, roughness of the rough surface of the flexible substrate 11 may be between 50 nm-5000 nm to ensure the adhesion between the flexible substrate 11 and the optical waveguide layer 12 to improve reliability of the adhesion between the flexible substrate 11 and the optical waveguide layer 12, such that reliability of an overall structure of the flexible optical waveguide board may be improved.

In the present embodiment, the cover layer 13 includes a cover film 131. In detail, material of the cover membrane 131 may be polyimide, fluorosilicone rubber, polyetheretherketone, and perfluorovinyl propylene copolymer.

In an implementation, the cover layer 13 further includes an adhesive bonding layer 132. As shown in FIG. 3, FIG. 3 is a structural schematic view of a flexible optical waveguide board according to a third embodiment of the present disclosure. The adhesive bonding layer 132 is disposed between the cover film 131 and the optical waveguide layer 12 to adhere the cover film 131 with the optical waveguide layer 12 to increase the adhesion between the cover film 131 and the optical waveguide layer 12.

In another implementation, the cover layer 13 includes only the cover film 131. As shown in FIG. 1 or FIG. 2, the cover film 131 is directly adhered to the surface of the optical waveguide layer 12 by press laminating.

According to the present embodiment, the surface of the side of the flexible substrate 11 is configured to be the rough surface, the optical waveguide layer 12 is disposed on the rough surface of the flexible substrate 11, and the cover layer 13 is disposed to cover the surface of the optical waveguide layer 12 away from the flexible substrate 11. In this way, the optical waveguide layer 12 is disposed between the flexible substrate 11 and the cover layer 13. The flexible substrate 11 and the cover layer 13 protect the optical waveguide layer 12 from external erosion. At the same time, the surface of the side of the flexible substrate 11 close to the optical waveguide layer 12 is configured to be the rough surface, such that the adhesion between the flexible substrate 11 and the optical waveguide layer 12 may be improved, and the stability of the flexible optical waveguide structure may be improved. In addition, the flexible substrate 11 and the cover layer 13 are both made of flexible media and have certain flexibility. Combining the flexible substrate 11 and the cover layer 13 with the rigid optical waveguide layer 12 improves the bending resistance of the optical waveguide layer 12, such that the optical waveguide layer 12 may be bent to some extent, ensuring the bending resistance of the entire flexible optical waveguide board.

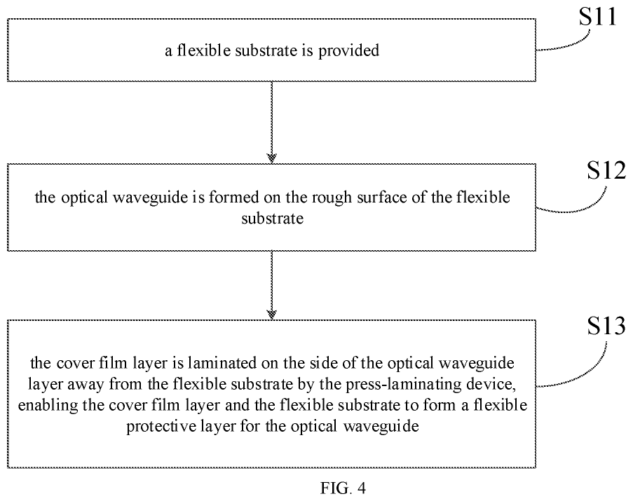

The present disclosure further provides a method of manufacturing a flexible optical waveguide board. As shown in FIG. 4, FIG. 4 is a flow chart of a method of manufacturing a flexible optical waveguide board according to an embodiment of the present disclosure. As shown in FIG. 4, the method includes following operations.

In an operation S11, a flexible substrate is provided.

A surface of a side of the flexible substrate is a rough surface. The flexible substrate is made of PI or other material used for manufacturing a flexible PCB, such as fluorosilicone rubber, PEEK, FEP, and so on, which will not be limited by the present disclosure. In the present embodiment, the PI may be taken as an example. As the PI film or other flexible material may have a smooth surface and have a low surface activation energy, the flexible substrate needs to be roughened in order to improve the adhesion between the flexible substrate and the optical waveguide layer, which may be made of optical resin.

In detail, the operation includes: performing a plasma beam treatment or a chemical etching process on the surface of the side of the flexible substrate close to the optical waveguide layer to form the rough surface; alternatively, disposing an adhesion layer on the surface of the side of the flexible substrate close to the optical waveguide layer to form the rough surface. The present disclosure does not limit a process for roughening.

In an operation S12, the optical waveguide layer is formed on the rough surface of the flexible substrate.

The optical waveguide layer includes a waveguide upper clad, a waveguide lower clad and a waveguide core layer. The optical waveguide layer is a polymeric optical waveguide layer and has high light transmission. The waveguide upper clad and the waveguide lower clad of the optical waveguide layer are optical resin layers to protect the waveguide core layer. In one implementation, the waveguide upper clad and the waveguide lower clad wrap the waveguide core layer.

In detail, the waveguide lower clad is coated on the rough surface of the flexible substrate, and an exposure process is performed on the waveguide lower clad to form a waveguide lower clad dry film. In detail, the operation includes: laminating the waveguide lower clad dry film on the surface of the flexible substrate by a press-laminating device; alternatively, forming a waveguide lower clad wet film on the surface of the flexible substrate by a coating device. The press-laminating device includes devices such as a vacuum laminator, a roller laminator and the like. The coating device includes devices such as a spin coater, a coater and the like. The present disclosure does not limit the devices to be used.

The waveguide core layer is formed on a surface of a side of the waveguide lower clad away from the flexible substrate. A molding-press process is performed to pattern the waveguide core layer to obtain lines of the waveguide core layer. In detail, the operation includes: forming the waveguide core layer on the surface of the waveguide lower clad by the press-laminating device or the coating device; and patterning the waveguide core layer by performing any one of a flatbed photocopying process, a laser direct writing process, a reactive ion etching process, and a nano-molding process.

At last, the waveguide upper clad is coated on a surface of a side of the waveguide core layer away from the waveguide lower clad to form the optical waveguide layer. In detail, the operation includes: forming the waveguide upper clad on the surface of the waveguide core layer by the press-laminating device or the coating device.

In an operation S13, the cover layer is laminated on the side of the optical waveguide layer away from the flexible substrate by the press-laminating device, enabling the cover layer and the flexible substrate to form a flexible protective layer for the optical waveguide.

In detail, the operation includes: laminating the cover layer to the waveguide upper clad by a vacuum hot laminator, serving as the protective layer, to improve structural reliability and environmental ageing resistance of the flexible optical waveguide board. For example, the cover layer may be a cover film.

In detail, the operation further includes: laminating an adhesive layer on the side of the optical waveguide layer away from the flexible substrate, and laminating the cover layer on the adhesive layer, thereby increasing the adhesion between the optical waveguide and the cover film layer.

In the present embodiment, the cover layer is made of combined material that includes: polyimide, fluorosilicone rubber, polyetheretherketone, perfluorovinyl propylene copolymer and the adhesive bonding layer.

Considering compatibility of manufacturing processes and application scenarios, material for making the FEOPCB (Flexible Electro-Optical Printed Circuit Board) needs to have a high dielectric property, high dimensional stability, high solvent resistance and high temperature resistance. A polyimide (PI) film may be applied in the present embodiment and has excellent physical and mechanical properties, thermal stability and dielectric properties. Therefore, the polyimide (PI) film is an ideal support carrier for flexible boards.

In detail, an example of taking PI as the flexible substrate will be illustrated. The PI film has a low surface activation energy. In order to improve the adhesion between the PI film and the optical resin, the surface of the PI film is roughened by the ion beam. The waveguide material is then cladded on the surface of the PI film by the press-laminating device. Alternatively, a coating process is performed on the surface of the PI film to form the waveguide lower clad. The waveguide lower clad is shaped by exposing and baking. Further, a same process is performed to form the core layer of the waveguide film on the surface of the waveguide lower clad. The waveguide circuit is then manufacture by flatbed photocopying, laser direct writing, reactive ion etching and nano-molding. The waveguide upper clad is laminated on a surface of the waveguide core layer by the press-laminating device, alternatively, the waveguide lower clad is laminated on the surface of the waveguide core layer by the coating device. The cover film is laminated on the waveguide upper clad by the press-laminating device as the protective layer to further improve the reliability and environmental ageing resistance of the flexible optical waveguide structure. The cover film may be made of adhesive glue and one or more of PI (polyimide), fluorosilicone rubber, PEEK, FEP, and the like.

According to the present disclosure, a flexible substrate is provided. At least one surface of the flexible substrate is a rough surface. The optical waveguide is formed on the rough surface of the flexible substrate. The cover film layer is laminated on the side of the optical waveguide away from the flexible substrate by the press-laminating device, such that the cover film layer and the flexible substrate form the flexible protective layer for the optical waveguide. In this way, the structural reliability and environmental aging resistance of the flexible optical waveguide may be improved. In addition, the flexible substrate and the cover film layer are both made of flexible medium material, which has certain flexibility. Combining the flexible substrate and the cover film layer with the rigid optical waveguide plate improves the bending resistance of the optical waveguide plate. In this way, the optical waveguide plate can be bent to some extent, ensuring the bending resistance of the entire flexible optical waveguide board.

The above description shows embodiments of the present disclosure and does not limit the scope of the present disclosure. Any equivalent structure or equivalent process transformation performed based on the content of the specification and accompanying drawings of the present disclosure, directly or indirectly applied in other related fields, shall be covered by the scope of the present disclosure.

What is claimed is:

1. A flexible optical waveguide board, comprising:
a flexible substrate, wherein a surface of a side of the flexible substrate is a rough surface;
an optical waveguide layer, disposed on the rough surface of the flexible substrate;
a cover layer, disposed on a surface of a side of the optical waveguide layer away from the flexible substrate.

2. The flexible optical waveguide board according to claim 1, wherein the optical waveguide layer comprises a waveguide lower clad, a waveguide upper clad and a waveguide core layer disposed between the waveguide upper clad and the waveguide lower clad; and
the waveguide lower clad is disposed on a side of the waveguide core layer close to the flexible substrate, and the waveguide upper clad is disposed on a side of the waveguide core layer close to the cover layer.

3. The flexible optical waveguide board according to claim 2, wherein each of the waveguide upper clad and the waveguide lower clad comprises an optical resin layer.

4. The flexible optical waveguide board according to claim 2, wherein the optical waveguide layer comprises a polymeric optical waveguide.

5. The flexible optical waveguide board according to claim 1, wherein the flexible substrate comprises one or more of polyimide, fluorosilicone rubber, polyetheretherketone, or perfluorovinyl propylene copolymer.

6. The flexible optical waveguide board according to claim 1, wherein roughness of the rough surface is in a range of 50 nm to 5000 nm.

7. The flexible optical waveguide board according to claim 1, wherein the cover layer comprises polyimide, fluorosilicone rubber, polyetheretherketone, perfluorovinyl propylene copolymer and adhesive glue.

8. The flexible optical waveguide board according to claim 2, wherein the waveguide core layer comprises a plurality of optical waveguide units that are spaced apart from each other;
the waveguide lower clad and the waveguide upper clad are received in a gap between the plurality of optical waveguide units to completely wrap the waveguide core layer.

9. The flexible optical waveguide board according to claim 1, wherein an adhesion layer is disposed on the side of the flexible substrate close to the optical waveguide layer to serve as the rough surface.

10. A method of manufacturing the flexible optical waveguide board, comprising:
providing a flexible substrate, wherein a surface of a side of the flexible substrate is a rough surface;
forming an optical waveguide layer on the rough surface of the flexible substrate;
laminating a cover layer on a surface of a side of the optical waveguide layer away from the flexible substrate by a press-laminating device, wherein the cover layer and the flexible substrate serve as a flexible protective layer for the optical waveguide layer.

11. The method according to claim 10, wherein the providing a flexible substrate, comprises:
roughening the surface of the side of the flexible substrate close to the optical waveguide layer by performing a plasma beam treatment.

12. The method according to claim 10, wherein the providing a flexible substrate, comprises:
roughening the surface of the side of the flexible substrate close to the optical waveguide layer by performing a chemical etching process.

13. The method according to claim 10, wherein the providing a flexible substrate, comprises:
disposing an adhesion layer on the side of the flexible substrate close to the optical waveguide layer to form the rough surface.

14. The method according to claim 10, wherein the forming an optical waveguide layer on the rough surface of the flexible substrate, comprises:
coating a waveguide lower clad on the rough surface of the flexible substrate, and exposing the waveguide lower clad;
forming a waveguide core layer on a side of the waveguide lower clad away from the flexible substrate; and
coating a waveguide upper clad on a side of the waveguide core layer away from the waveguide lower clad.

15. The method according to claim 14, wherein the forming a waveguide core layer on a side of the waveguide lower clad away from the flexible substrate, comprises:
patterning the waveguide core layer by performing a chemical process, such that the waveguide core layer has a pattern.

16. The method according to claim 15, wherein the chemical process comprises any one of flatbed photocopying, laser direct writing, reactive ion etching, nano-molding.

17. The method according to claim 10, wherein the flexible substrate is made of material comprising any one or more of polyimide, fluorosilicone rubber, polyetheretherketone, and perfluorovinyl propylene copolymer.

18. The method according to claim 10, wherein the cover layer comprises polyimide, fluorosilicone rubber, polyether ether ketone, perfluorovinyl propylene copolymer and adhesive glue.

19. The method according to claim 10, wherein roughness of the rough surface is in a range of 50nm-5000 nm.

20. The method according to claim 14, wherein the waveguide core layer comprises a plurality of optical waveguide units that are spaced apart from each other;
the waveguide lower clad and the waveguide upper clad are received in a gap between the plurality of optical waveguide units to completely wrap the waveguide core layer.
